(19) United States
(12) Patent Application Publication
(10) Pub. No.: US 2006/0193570 A1
(43) Pub. Date: Aug. 31, 2006

(54) Tube bundle for optical fibres, and method of manufacturing such bundle

(76) Inventor: George Henry Platt Brown, Galashiels (GB)

Correspondence Address: JACKIE JAY SCHWARTZ, 1350 Broadway, Suite 1510, NEW YORK, NY, 10018, US

(21) Appl. No.: 11/404,046

(22) Filed: Apr. 13, 2006

Related U.S. Application Data
(63) Continuation-in-part of application No. PCT/GB05/02945, filed on Jul. 27, 2005.

(30) Foreign Application Priority Data
Aug. 12, 2004 (GB) 0417981.8
Aug. 12, 2004 (GB) 0417982.6

(51) Int. Cl. G02B 6/44

(52) U.S. Cl. 385/100; 385/102; 385/103; 385/104; 385/106; 385/107; 385/109; 385/110; 385/112; 385/113

(57) ABSTRACT

A tube assembly (202) for installation of one or more optical fibres is disclosed. The assembly comprises a plurality of elongate flexible first tubes (204) for receiving one or more optical fibres. A first layer (206) is arranged outwardly of the tubes, and a second layer (220) is arranged radially inwardly of the first layer to substantially fill a void between at least the radially outermost first tubes and the first layer.

### CROSS-REFERENCE TO RELATED APPLICATIONS

This is a Continuation-in-Part Application of PCT Patent Application No. PCT/GB2005/002945 filed on Jul. 27, 2005.

### FIELD OF THE INVENTION

The present invention relates to a tube bundle and relates particularly, but not exclusively, to a tube bundle for receiving optical fibres by means of blowing using compressed air. The invention also relates to a method of manufacturing such a tube bundle.

### BACKGROUND OF THE INVENTION

Fibre optic cables used for providing telecommunications and data communications services have traditionally been relatively large in diameter. More recently, the trend has been for the diameter of such cables to reduce, primarily because new techniques for installation of fibre optic cables by blowing impose much less strain on the cables than traditional methods which involve pulling the cables into ducts with a winch. As a result, it has been possible to reduce the extent to which the fibre optic cables are reinforced in order to protect the individual glass fibre optic elements during installation, which has in turn resulted in cables becoming more lightweight and smaller in diameter.

This reduction in the diameter of fibre optic cables has produced a corresponding reduction in the diameter of the tubes into which the cables are installed. For example, these tubes which were traditionally 40 mm or 50 mm in diameter are now 10 mm or smaller in diameter, and some tubes are now manufactured for the installation of fibre optic cables with diameters as small as 3 mm.

These smaller diameter tubes are usually assembled as bundles. This was not possible with the older large diameter tubes, but the smaller tubes can conveniently be assembled as bundles of multiple small diameter tubes, and the assembly remains sufficiently flexible to allow the tube bundle to be wound onto a drum and provide a convenient size for installation in a telecommunications network. Tube bundles are typically manufactured with 2, 4, 7, 12, 19 or 24 tubes, surrounded by an outer sheath to create a tube cable. Such a tube cable 2 having 7 tubes is illustrated in FIG. 1 and comprises 7 tubes 4 and a sheath 6, voids 8 separating the individual tubes 4 and the sheath 6. The individual tubes 4 are manufactured from polyethylene, and the sheath 6 typically comprises a first layer 10 of aluminium tape and a second layer 12, and in some cases a third layer, comprising different grades of polyethylene. The aluminium layer 10 provides a barrier to water permeation, and prevents the polyethylene layer 12 of the sheath 6 from sticking to the polyethylene of the individual tubes 4 during manufacture. During manufacture of the cable 2, the polyethylene layer 12 of the sheath 6 is extruded at high temperature over the top of the assembled tubes 4, and if this hot polyethylene layer 12 were to come into direct contact with the polyethylene of the individual tubes 4, it is likely that the tubes 4 would become adhered to the sheath 6. This can cause problems in gaining access to the individual tubes of the cable for connection purposes.

This type of tube bundle is used extensively for outside plant applications and provides excellent resistance to water penetration. However such cables suffer from the disadvantage that if the sheath 6 of the tube cable 2 should become damaged, water can enter the voids 8 between the individual tubes 4 and travel for considerable distances axially along the cable, potentially flooding low lying parts of the network into which the cable is installed.

It is also known to manufacture tube cables with a single layer of plasticised polyvinyl chloride (PVC) as a sheath. Plasticised PVC has been used to provide simple circular sheaths, and also sheaths which fill the voids on the outer periphery of tube assemblies, and has the benefit of being incompatible with polyethylene and is extruded at a lower temperature compared with polyethylene. As a result, plasticised PVC does not adhere to the polyethylene tubes, and can therefore be extruded in intimate contact with polyethylene tubes. However, plasticised PVC suffers from the drawback that it is not suitable for installation in outside plant applications, where tube cables might be directly buried or located in flooded manholes, since plasticised PVC is relatively soft, providing poor resistance to abrasion and compression and has poor resistance to water permeation compared to polyethylene. For this reason, tube bundles which have a flexible PVC sheath are presently only used for in-building applications, where the PVC is useful in preventing the spread of fire.

Attempts have been made to overcome the problem of water penetration and flooding by means of the use of a curable resin which is inserted into the voids of the tube cable at each point where the tube cable is cut or terminated. This prevents flooding because the water is always contained within the voids and cannot escape. However, it is generally considered undesirable to have the voids between tubes permanently full of water, since the water can freeze and expand creating significant compressive forces, potentially affecting the transmission performance of the cables or collapsing empty tubes and thus preventing cable installation.

It has therefore been considered desirable to prevent water filling the voids between tubes in the event that the outer sheath has been damaged, and such an arrangement is shown in FIG. 2. A cable 102 designed to prevent water filling the voids 108 between the individual tubes 104 if the sheath 106 is damaged has water swellable tapes 114, 116 wrapped around the tube assembly and the individual tubes 104 respectively, and the sheath 106 then surrounds the tubes 104. Such water swellable tapes 114, 116, which are well known to persons skilled in the art of cable manufacture, include a highly absorbent material such as super absorbent gel, and swell when they come into contact with water so much that they can fill the voids 108 between the tubes 104 and prevent the water travelling very far from the point at which the tube cable is damaged.

However, the use of water swellable tapes suffers from the drawback that the tapes are preferably wrapped individually around each of the tubes before the tube cable is assembled. This is a time consuming and expensive process, particularly if the number of tubes in the cable is large. Also, if the individual tubes are large in diameter, then the voids, in particular on the outer circumference of the tube assembly, potentially become so large that the water swellable tapes cannot expand sufficiently to fill the void.

Preferred embodiments of the present invention seek to overcome the above disadvantages of the prior art.

### SUMMARY OF THE INVENTION

According to an aspect of the present invention, there is provided a tube assembly for installation of one or more optical fibres, the assembly comprising a plurality of elongate flexible first tubes for receiving one or more optical fibres, a first layer arranged outwardly of said tubes, and a second layer arranged radially inwardly of the first layer to substantially fill a void between at least the radially outermost first tubes and said first layer.

By providing a second layer arranged radially inwardly of the first layer to substantially fill a void between at least the radially outermost first tubes and the first layer, this provides the advantage that by suitable choice of the materials forming the first tubes, the first layer and the second layer, a tube assembly that is highly resistant to moisture penetration can be produced relatively cost effectively.

By providing a second layer arranged radially inwardly of the first layer to substantially fill a void between at least the radially outermost first tubes and the first layer, this provides the further advantage that a third layer may be disposed between the first and second layers, the third layer being supported by the second layer. In providing such a support for the third layer, this means that the third layer can be made thinner than would be the case if no second layer were present. This also means that the first layer is able to be extruded over the third layer without the assembly collapsing. In having a relatively thin third layer, this significantly reduces costs.

Said second layer may be adapted to resist axial movement of moisture along said assembly.

The second layer may include at least one moisture absorbent material.

At least one said moisture absorbent material may be adapted to expand in response to contact with moisture.

The second layer may include polypropylene or polyethylene.

This provides the advantage of producing fewer toxic fumes than other materials such as PVC in the event of combustion. In addition, the use of polypropylene or polyethylene provides the advantage that they are relatively easy to foam for example with blowing agents or gas injection, as a result of which it is possible to produce low-density foams, which significantly reduces the cost of the second layer, while also enabling the assembly to have the desired stiffness and strength.

The second layer may include a material which is incompatible with the material from which the tubes are made.

This enables the assembly to be easier to strip.

The tubes may be coated with an adherence reducing substance.

This has the advantage of reducing the number of different polymers involved in the manufacturing process resulting in reduced inventory. For example, the adherence reducing material may be a powder allowing the use of a compatible material for the second layer.

The second layer may include mineral additives.

This provides the advantage of reducing the cost of the assembly and also may be advantageously used to increase the stiffness of the second layer to provide additional protection.

At least one said first tube and/or said second layer may include at least one reduced fire hazard material.

This provides the advantage of minimising the production of smoke and toxic fumes in the event of combustion.

Said first layer may place said second layer under compression.

This provides a number of surprising benefits. For example, by suitable choice of material of the first and second layers, for example polyethylene for the first layer and plasticized PVC for the second layer, it has been found that the polyethylene of the first layer shrinks, after extrusion, onto the relatively flexible inner PVC layer providing a significant degree of compression. This provides the advantage of locking the inner first tubes in place relative to each other and considerably increasing the compression strength of the entire assembly than would be the case if the first layer were loose around the second layer. The compression of the second layer also serves to prevent channels being left open between the first tubes and the second layer down which water may be able to penetrate. If the voids in which water can collect are small then the consequences of such water freezing and expanding are also small, thus having little impact on the overall performance of the tube cable and any fibre optic cables already installed in the tube cable. In addition, it is found that the tube assembly has excellent bending properties with little or no tendency to kink or distort the inner first tubes.

The first layer may include at least one fire resistant material.

For example, the fire resistant material could be Nomex™ manufactured by Dupont.

The first layer may include copper and/or steel.

This provides the advantage that the assembly has improved fire resistance and moreover, is less likely to generate smoke or toxic fumes in the event of a fire.

The first layer may be corrugated.

This provides the advantage of making the assembly easier to bend.

The assembly may further comprise a third layer arranged between said first and second layers to resist moisture penetration into said second layer.

The third layer may include aluminium.

The third layer may include a powder adapted to expand in response to contact with moisture.

The third layer may include tape coated with a powder adapted to expand in response to contact with moisture.

The third layer may include an adhesive.

In having the third layer including an adhesive, this provides the advantage that the first layer may be bonded to the second layer, thereby ensuring that the assembly can be bent during manufacture and installation for example, without the first layer kinking. This is particularly the case when the first layer includes a metal, since metals are particularly susceptible to kinking.

The first layer may include polyethylene.

The second layer may include polyvinyl chloride.

The second layer may include plasticized polyvinyl chloride.

The second layer may include at least one foam material.

The assembly may further comprise at least one moisture absorbent material adapted to expand in response to contact with moisture and arranged radially inwardly of the first layer.

At least one said moisture absorbent material may comprise at least one tape.

At least one said moisture absorbent material may comprise at least one yarn.

At least one moisture absorbent material may comprise a powder.

The assembly may further comprise at least one filler member for at least partially filling at least one void between at least one said first tube and said first layer and/or between a plurality of said first tubes.

At least one said filler member may comprise a respective elongate flexible second tube of smaller diameter than a said first tube.

According to another aspect of the present invention, there is provided a method of forming a tube assembly for installation of one or more optical fibres, the method comprising arranging a plurality of elongate flexible first tubes relative to each other, and forming first and second layers around said tubes, wherein said second layer is radially inwardly of said first layer and substantially fills the voids between the radially outermost first tubes and the first layer.

Said first and second layers may be formed by means of extrusion.

The first layer may place the second layer under compression.

The method may further comprise the step of forming a third layer outwardly of said second layer to resist moisture penetration into said second layer.

The method may further comprise the step of including a blowing agent in said second layer.

The method may include the step of injecting gas into the second layer.

The method may further comprise the step of inserting at least one moisture absorbent material in the assembly.

A preferred embodiment of the invention will now be described, by way of example only and not in any limitative sense, with reference to the accompanying drawings, in which:—

### BRIEF DESCRIPTION OF THE DRAWING FIGURES

FIG. 1 shows a schematic cross sectional view of a known tube bundle;

FIG. 2 shows a view, corresponding to FIG. 1, of a known tube bundle for preventing water penetration;

FIG. 3 shows a view, corresponding to FIG. 1, of a tube bundle embodying the present invention; and

FIG. 4 shows a view, corresponding to FIG. 1, of a tube bundle embodying a further embodiment of the present invention.

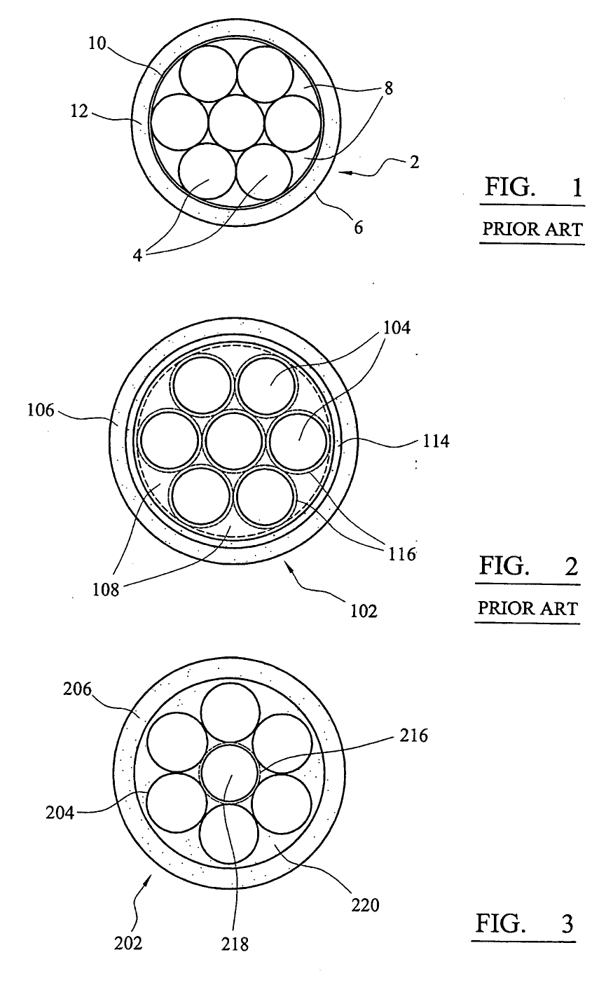

### DETAILED DESCRIPTION

Referring to FIG. 3, a flexible tube assembly 202 for receiving one or more optical fibres (not shown) by blowing is formed by wrapping a water swellable tape 216 around a central polyethylene tube 218, and then surrounding the central tube 218 with 6 similar tubes 204 of polyethylene. A layer of foam plasticised polyvinylchloride (PVC) 220 is extruded around the outer polyethylene tubes 204 such that the gaps between the outermost polyethylene tubes 204 are filled, and at the same time an outer sheath 206 of polyethylene is extruded over the PVC layer 220.

The use of foam plasticised PVC provides flexibility and ease of removal in the final product to expose the inner tubes 204 for blowing of optical fibres into the tubes 204, as well as the benefit of light weight and reducing the raw material cost. Because of the incompatibility of PVC with polyethylene, the PVC layer 220 can be extruded in such a way that it is in intimate contact with the inner polyethylene tubes 204 and fills the voids between the outermost tubes 204, without adhering excessively to the polyethylene tubes 204. As the PVC and polyethylene cool, the polyethylene outer layer 206 shrinks during cooling so that it shrinks onto the relatively flexible PVC inner layer 220, providing a significant degree of compression. This provides the advantage of not only locking the inner polyethylene tubes 204 in place relative to each other, but considerably increases the compression strength of the entire cable compared with the case of a loose polyethylene layer 206 outside the PVC layer 220.

The compression of the PVC layer 220 also serves to prevent channels being left open between the tubes 204 and the PVC layer 220 along which water may be able to penetrate, and the entire assembly has excellent bending properties with little or no tendency to kink or distort the inner polyethylene tubes 204, 218. The soft PVC layer 220 also provides an effective buffer between the inner polyethylene 204 tubes and the harder polyethylene outer layer 206 which is particularly beneficial with larger diameter tubes, for example 10 mm plus tubes, that distort relatively easily when the assembly is bent around a tight bending radius.

In order to reduce the cost of the polymer used to fill the internal and external voids, it is possible to include a blowing agent in the polymer, or to inject gas into the polymer so that lightweight foam is created. As a result of only the voids on the outermost layer of the tube bundle being filled, a more compact smaller diameter tube cable can be manufactured. This also has the benefit that the outer tubes 204 do not need to be individually wrapped with water swellable tapes, which significantly reduces the cost of manufacture of the cable.

The inner voids may be filled in other ways than by wrapping a water swellable tape around the innermost polyethylene tube 218. For example, water swellable yarns or water swellable powder may be used instead of tapes. In addition, the size of the internal voids can be significantly reduced by providing fillers, for example smaller diameter tubes that fit neatly into the void. The use of such fillers enables water swellable powder alone to be used, as opposed to water swellable tapes or yarns, as a result of which the cost of manufacture of the assembly is reduced. It is also possible to provide a water swellable tape between the interface of the soft flexible polymer 220 and the tubes 204, in which case the individual outer tubes 204 do not need to have water swellable tapes wrapped around them, but instead the water swellable tape can be laid between the outermost polyethylene tubes 204 and the PVC layer as the cable is being assembled. This additionally saves labour and cost. In the same way, the outermost polyethylene tubes 204 can be coated with a water swellable powder at the same time as the inner tube 218 is coated.

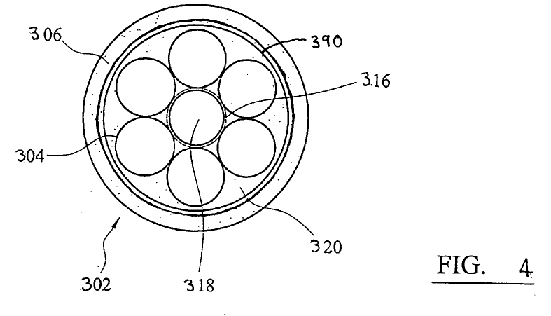

Referring now to FIG. 4, a further embodiment of a flexible tube assembly for receiving one or more optical fibres (not shown) by blowing is shown by reference numeral 302. The assembly 302 is formed by wrapping a water swellable tape 316 around a central polyethylene tube 318, and then surrounding the central tube 318 with 6 similar tubes 304 of polyethylene. A layer of foam plasticised polyvinylchloride (PVC) 320 is extruded around the outer polyethylene tubes 304 such that the gaps between the outermost polyethylene tubes 304 are filled. An outer sheath 306 of polyethylene is formed outwardly of the PVC layer 320. The assembly 302 differs from that shown in FIG. 3 in that a third layer 390 is additionally formed between the PVC layer 320 and the outer sheath 306.

The third layer 390 is in the form of an aluminium layer, which is most conveniently provided by wrapping the outer surface of the PVC layer 320 with an aluminium foil before the outer polyethylene layer 306 is applied. Aluminium has excellent properties in preventing water permeation, and when combined with the benefits of the PVC layer 320 provide a tube cable with significant advantages.

The presence of the PVC layer 320 means that the aluminium layer may be made relatively thin, since the PVC layer 320 provides support.

It is to be appreciated that the third layer may alternatively take the form of a water swellable powder disposed between the PVC layer 320 and the outer polyethylene layer 306. Alternatively, the third layer may be tape coated with water swellable powder.

Alternatively, the third layer may take the form of an adhesive. This ensures that the assembly can be bent without the outer layer 306 kinking. This is particularly the case when the outer layer 306 is made from metal.

It will be appreciated by persons skilled in the art that the above embodiment has been described by way of example only, and not in any limitative sense, and that various alterations and modifications are possible without departure from the scope of the invention as defined by the appended claims. For example, the water swellable material 216 applied to the innermost tube 218 may be a water swellable material applied by electrostatic coating, and the polyethylene sheath 206 may be omitted so that the outermost layer of the assembly is the plasticized PVC coating 220.

1. A tube assembly for installation of one or more optical fibres, the assembly comprising a plurality of elongate flexible first tubes for receiving one or more optical fibres, a first layer arranged outwardly of said tubes, and a second layer arranged radially inwardly of the first layer to substantially fill a void between at least the radially outermost first tubes and said first layer.

2. An assembly according to claim 1, wherein said second layer is adapted to resist axial movement of moisture along said assembly.

3. An assembly according to claim 2, wherein the second layer includes at least one moisture absorbent material.

4. An assembly according to claim 3, wherein at least one said moisture absorbent material is adapted to expand in response to contact with moisture.

5. An assembly according to claim 1, wherein the second layer includes polypropylene or polyethylene.

6. An assembly according to claim 1, wherein the second layer includes a material which is incompatible with the material from which the tubes are made.

7. An assembly according to claim 1, wherein the tubes are coated with an adherence reducing substance.

8. An assembly according to claim 1, wherein the second layer includes mineral additives.

9. An assembly according to claim 1, wherein at least one said first tube and/or said second layer includes at least one reduced fire hazard material.

10. An assembly according to claim 1, wherein said first layer places said second layer under compression.

11. An assembly according to claim 1, wherein the first layer includes at least one fire resistance material.

12. An assembly according to claim 11, wherein the first layer includes copper and/or steel.

13. An assembly according to claim 1, wherein the first layer is corrugated.

14. An assembly according to claim 1, further comprising a third layer arranged between said first and second layers to resist moisture penetration into said second layer.

15. An assembly according to claim 14, wherein the third layer comprises aluminium.

16. An assembly according to claim 14, wherein the third layer comprises a powder adapted to expand in response to contact with moisture.

17. An assembly according to claim 14, wherein the third layer comprises tape coated with a powder adapted to expand in response to contact with moisture.

18. An assembly according to claim 14, wherein the third layer comprises an adhesive.

19. An assembly according to claim 1, wherein the first layer includes polyethylene.

20. An assembly according to claim 1, wherein the second layer includes polyvinyl chloride.

21. An assembly according to claim 20, wherein the second layer includes plasticized polyvinyl chloride.

22. An assembly according to claim 1, wherein the second layer includes at least one foam material.

23. An assembly according to claim 1, further comprising at least one moisture absorbent material adapted to expand in response to contact with moisture and arranged radially inwardly of the first layer.

24. An assembly according to claim 3, wherein at least one said moisture absorbent material comprises at least one tape.

25. An assembly according to claim 3, wherein at least one said moisture absorbent material comprises at least one yarn.

26. An assembly according to claim 3, wherein at least one moisture absorbent material comprises a powder.

27. An assembly according to claim 1, further comprising at least one filler member for at least partially filling at least one void between at least one said first tube and said first layer and/or between a plurality of said first tubes.

28. An assembly according to claim 27, wherein at least one said filler member comprises a respective elongate flexible second tube of smaller diameter than a said first tube.

29. A method of forming a tube assembly for installation of one or more optical fibres, the method comprising arranging a plurality of elongate flexible first tubes relative to each other, and forming first and second layers around said tubes, wherein said second layer is radially inwardly of said first layer and substantially fills the voids between the radially outermost first tubes and the first layer.

30. A method according to claim 29, wherein said first and second layers are formed by means of extrusion.

31. A method according to claim 29, wherein the first layer places the second layer under compression.

32. A method according to claim 29, further comprising the step of forming a third layer outwardly of said second layer to resist moisture penetration into said second layer.

33. A method according to claim 29, further comprising the step of including a blowing agent in said second layer.

34. A method according to claim 29, further comprising the step of injecting gas into the second layer.

35. A method according to claim 29, further comprising the step of inserting at least one moisture absorbent material in the assembly.
